(19) United States
(12) Patent Application Publication
(10) Pub. No.: US 2019/0129828 A1
(43) Pub. Date: May 2, 2019

(54) GATHERING COVERAGE METRICS FOR STATIC PROGRAM ANALYSIS TOOLS

(71) Applicant: International Business Machines Corporation, Armonk, NY (US)

(72) Inventors: Omer Tripp, Bronx, NY (US); Marco Pistoia, Amawalk, NY (US)

(21) Appl. No.: 15/799,530

(22) Filed: Oct. 31, 2017

(51) Int. Cl. G06F 11/36

(52) U.S. Cl. CPC G06F 11/3624; G06F 11/3616

(57) ABSTRACT

Gathering coverage metrics for a static analysis procedure by injecting one or more property violations into a program to be examined by the procedure, recording a first list identifying the one or more injected property violations, executing the static analysis procedure to detect at least one of the one or more injected property violations, recording a second list identifying the detected at least one of the one or more injected property violations, and comparing the first list to the second list to gather a set of coverage metrics for the static analysis procedure, The comparing identifies a first set of injected property violations that are not identified by the static analysis procedure, and a second set of injected property violations that are identified by the static analysis procedure. A coverage metrics report is generated that indicates the extent to which the procedure is able to detect vulnerabilities in the program.

### FIELD

The present application relates generally to static program analysis and, more particularly, to techniques for gathering coverage metrics for static program analysis tools.

### BACKGROUND

Static program analysis refers to analyzing computer software without actually executing the software. More specifically, static program analysis is a collective term that refers to a rich and diverse set of techniques and algorithms targeting many different problem domains. Some illustrative examples of problem domains include security, runtime bugs, null dereferences, and performance analysis. Commercial static analysis tools are required to scale to industrial-sized programs that include millions of lines of code, along with supporting libraries that contain tens of millions of lines of code. In many cases, the behavior of the static analysis tool is governed by a set of configuration parameters. This holds true for security analysis tools including IBM Security AppScan Source Edition™, KlockWork™, and HP Fortify 360™.

The tool configuration parameters define how deep the static analysis should be, how precise the analysis should be, and what the analysis budget is in terms of memory footprint and time. These aspects of the static analysis are essential to ensure timely completion of the analysis, given the typical or predicted scale of programs to which the analysis is going to be applied. In certain cases, a set of one or more additional parameters that relate more intimately to the internal workings of the analysis may also be specified.

The configuration parameters bound the static analysis, thereby guaranteeing its efficiency and acceptable behavior in terms of resource consumption. At the same time, however, the configuration parameters may potentially lead to “false negatives” where a significant issue is missed by the static analysis. Unfortunately, current static analysis tools do not provide any measure or insight into the level of coverage of a target application per a given configuration. The user can guarantee that the static analysis was executed efficiently, but no indication is provided to the user as to how thoroughly the analysis scanned the code, in terms of breadth and depth. Thus, there exists a need to overcome at least one of the preceding deficiencies and limitations of the related art.

### SUMMARY

The following summary is merely intended to be exemplary. The summary is not intended to limit the scope of the claims.

A computer-executed method, in one aspect, comprises injecting one or more property violations into a program to be examined by a static analysis procedure, wherein the one or more property violations are to be enforced by the static analysis procedure, and the one or more property violations are inserted at random locations within the program, or at designated locations within the program, or at both designated and random locations within the program. A first list identifying the one or more injected property violations is recorded into a non-transitory computer-readable storage medium. The static analysis procedure is executed to detect at least one of the one or more injected property violations. A second list identifying the detected at least one of the one or more injected property violations is recorded into the non-transitory computer-readable storage medium. The first list is compared to the second list to gather a set of coverage metrics for the static analysis procedure. This comparison identifies a first set of injected property violations that are not identified by the static analysis procedure, and a second set of injected property violations that are identified by the static analysis procedure. A coverage metrics report is generated using the first and second sets of injected property violations. The coverage metrics report provides an indication as to the extent that the static analysis procedure is able to detect one or more vulnerabilities in the program.

A computer program product, in another aspect, comprises a non-transitory computer-readable storage medium having a computer-readable analysis program stored therein, wherein the computer-readable analysis program, when executed on a computer system comprising at least one processor, causes the computer system to inject one or more property violations into a program to be examined by a static analysis procedure, wherein the one or more property violations are to be enforced by the static analysis procedure, and the one or more property violations are inserted at random locations within the program, or at designated locations within the program, or at both designated and random locations within the program. A first list identifying the one or more injected property violations is recorded into the non-transitory computer-readable storage medium. The static analysis procedure is executed to detect at least one of the one or more injected property violations. A second list identifying the detected at least one of the one or more injected property violations is recorded into the non-transitory computer-readable storage medium. The first list is compared to the second list to gather a set of coverage metrics for the static analysis procedure. This comparison identifies a first set of injected property violations that are not identified by the static analysis procedure, and a second set of injected property violations that are identified by the static analysis procedure. A coverage metrics report is generated using the first and second sets of injected property violations. The coverage metrics report provides an indication as to the extent that the static analysis procedure is able to detect one or more vulnerabilities in the program.

An apparatus, in another aspect, may comprise a processor and a non-transitory computer-readable memory coupled to the processor, wherein the memory comprises instructions which, when executed by the processor, cause the processor to inject one or more property violations into a program to be examined by a static analysis procedure, wherein the one or more property violations are to be enforced by the static analysis procedure, and the one or more property violations are inserted at random locations within the program, or at designated locations within the program, or at both designated and random locations within the program. A first list identifying the one or more injected property violations is recorded into the non-transitory computer-readable storage medium. The static analysis procedure is executed to detect at least one of the one or more injected property violations. A second list identifying the detected at least one of the one or more injected property violations is recorded into the non-transitory computer-readable storage medium. The first list is compared to the second list to gather a set of coverage metrics for the static analysis procedure. This comparison identifies a first set of injected property violations that are not identified by the static analysis procedure, and a second set of injected property violations that are identified by the static analysis procedure. A coverage metrics report is generated using the first and second sets of injected property violations. The coverage metrics report provides an indication as to the extent that the static analysis procedure is able to detect one or more vulnerabilities in the program.

### BRIEF DESCRIPTION OF THE SEVERAL VIEWS OF THE DRAWINGS

The foregoing aspects and other features are explained in the following description, taken in connection with the accompanying drawings, wherein:

FIG. 1 is a flowchart illustrating an exemplary method that gathers a set of coverage metrics for a static analysis procedure.

FIG. 2 is a flowchart illustrating an exemplary set of injected property violations for use with the method of FIG. 1.

FIG. 3 is a hardware block diagram of an exemplary computer or processing system that may implement the method of FIG. 1, in one set of embodiments of the present disclosure.

### DETAILED DESCRIPTION

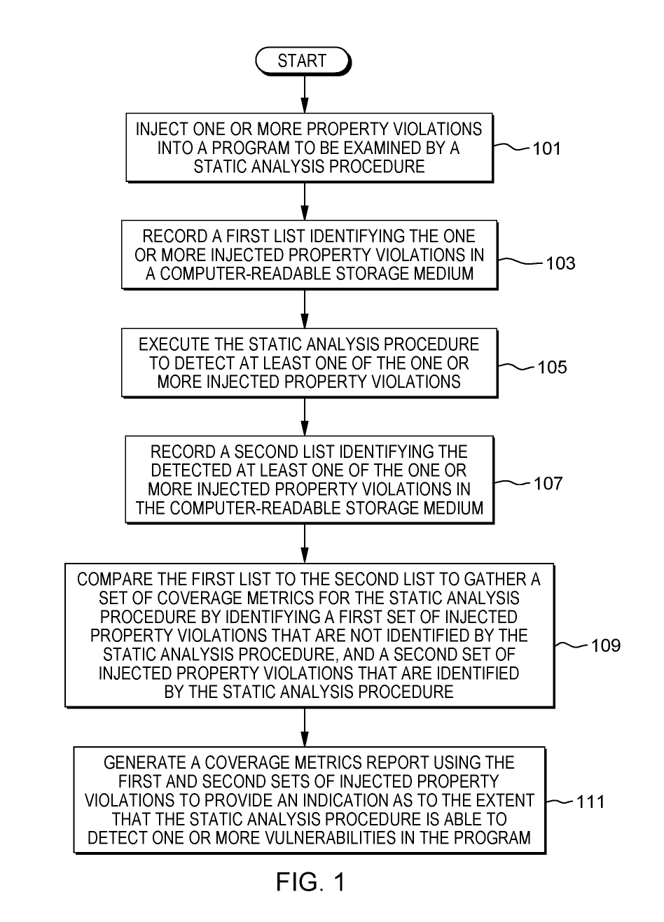

FIG. 1 is a flowchart illustrating an exemplary method that gathers a set of coverage metrics for a static analysis procedure. The procedure commences at block 101 where one or more property violations are injected into a program to be examined by a static analysis procedure. According to one set of embodiments, the one or more property violations are inserted at random locations within the program. According to another set of embodiments, the one or more property violations are inserted at designated, predetermined, or specified locations within the program. According to yet another set of embodiments, the one or more property violations are inserted at both designated and random locations within the program.

Each of the one or more property violations are to be enforced by the static analysis procedure. In general, software programs must meet certain requirements that should never be violated during program execution. These requirements are considered to be properties of the program. The one or more property violations may be injected into the program by synthesizing one or more encapsulated code fragments that violate one or more properties to be verified by the static analysis procedure. Each of these code fragments may represent a vulnerable flow having a pre-specified set of characteristics. For example, the flow may involve a heap versus a stack, or the flow may be of a variable length.

The method progresses to block 103 where a first list identifying the one or more injected property violations is recorded in a computer-readable storage medium. Next, at block 105, the static analysis procedure is executed to detect at least one of the one or more injected property violations. A second list identifying the detected at least one of the one or more property violations is recorded in the computer-readable storage medium (block 107). The first list and the second list are then compared to gather a set of coverage metrics for the static analysis procedure (block 109). This comparison identifies a first set of injected property violations that are not identified by the static analysis procedure, and a second set of injected property violations that are identified by the static analysis procedure. At block 111, a coverage metrics report is generated using the first and second sets of injected property violations. The coverage metrics report provides an indication as to the extent that the static analysis procedure is able to detect one or more vulnerabilities in the program.

The static program analysis procedure of FIG. 1 may be implemented using any analysis tool that is perforated without actually executing the code of a software program under examination. In some cases, the analysis is performed on source code, and in other cases, the analysis is performed on object code. In general, static program analysis takes place within a specific program or subroutine, without connecting to the context of that program. For purposes of illustration, the static program analysis may be configured to perform a security analysis.

Static program analysis may be performed on any of three basic levels. These include a technology level, a system level, and a mission/business level. The technology level takes into account interactions between a plurality of unit programs to obtain a holistic and semantic view of the overall program in order to locate issues and avoid obvious false positives. The system level takes into account interactions between unit programs, but without being limited to one specific technology or programming language. The mission/business level takes into account terms, rules and processes that are implemented within the software system for its operation as part of enterprise or program/mission layer activities. These elements are implemented without being limited to one specific technology or programming language and in many cases are distributed across multiple languages but are statically extracted and analyzed for system understanding for mission assurance.

Formal methods may be used to implement static program analysis. Formal methods refers to a category of analysis tools where results are obtained purely through the use of rigorous mathematical methods. Mathematical techniques such denotational semantics, axiomatic semantics, operational semantics, abstract interpretation, or any of various combinations thereof may be employed. However, using formal methods to locate all possible run-time errors in an arbitrary program (or more generally any kind of violation of a specification on the final result of a program) is an undecidable problem. No mathematical method exists that can always answer truthfully whether an arbitrary program may or may not exhibit runtime errors. This result dates from the works of Church, Gödel and Turing in the 1930s. As with many undecidable questions, one can still attempt to provide useful approximate solutions.

In practice, formal static program analysis may be implemented using model checking, data-flow analysis, abstract interpretation, Hoare logic, symbolic expression, or any of various combinations thereof. Model checking considers software that has finite states, or that may be reduced to finite states by abstraction. Data-flow analysis is a lattice-based technique for gathering information about a possible set of values. Abstract interpretation models an effect that each of a plurality of statements has on a state of an abstract machine. The software is “executed” based on the mathematical properties of each statement. However, this abstract machine over-approximates the behaviors of the software. The abstract software is thus made simpler to analyze, at the expense of incompleteness. Not every property true of the original software will be true of the abstracted software. If performed properly, abstract interpretation is a sound technique. Every property true of the abstracted software can be mapped to a true property of the original software.

Hoare logic is a formal system with a set of logical rules for reasoning rigorously about the correctness of computer programs. Symbolic execution is another formal system that is used to derive mathematical expressions representing values for a plurality of mutated variables at particular points in the code.

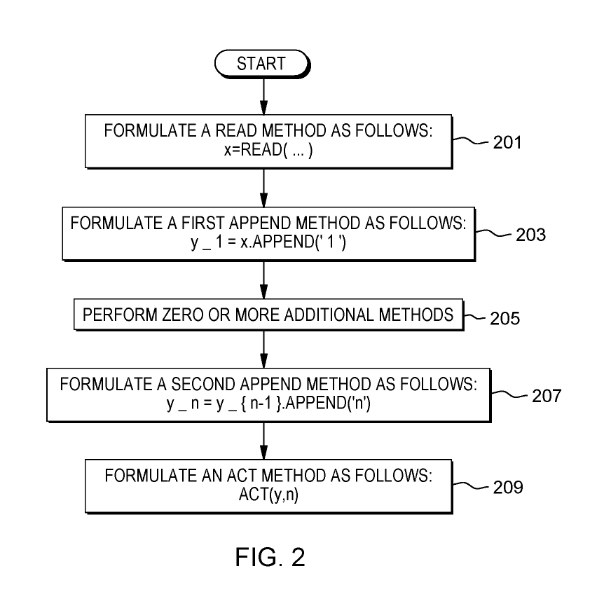

FIG. 2 is a flowchart illustrating an exemplary set of injected property violations for use with the method of FIG. 1. Consider a static analysis procedure which is configured to check for security vulnerabilities such as cross-site scripting (XSS), structured query language (SQL) injection, and log forging. In this context, block 101 of FIG. 1 may be implemented by injecting various types of vulnerable code fragments into the program, such that the static analysis procedure's coverage of untrusted information flows becomes measurable and quantifiable. FIG. 2 illustrates a first example of injecting property violations in the form of data flows of varying length, using the following pattern. At block 201, a READ method is formulated as follows: x=READ ( . . . ). The READ method reads at most a specified number of bytes from a file. If the READ method hits an end of file (EOF) before obtaining the specified number of bytes, the READ method only reads available bytes. For sequential access, the READ method can be used to make the next logical record from a file available to the program under test. For random access, the READ method can be used to make a specified record from a direct-access file available to the program under test.

At block 203, a first APPEND method is formulated as follows: y_1=x.append(‘1’). The APPEND method appends a passed object into an existing list to generate an updated list. At block 205, zero or more additional methods may be provided. Next, at block 207, a second APPEND method is formulated as: y_n=y_{n−1}.append(‘n’). Then, an ACT method is formulated as: act(y,n) at block 209. Thus, the program flow of FIG. 2 is configured for injecting data flows of varying lengths into the program under test. This provides an understanding of how capable the analysis is of dealing with long flows, where different lengths are tried. Alternatively or additionally, the analysis could inject data flows into methods that are varying or predetermined distances away from call-graph roots. Alternatively or additionally, the analysis could inject data flows into methods that are varying or predetermined distances away from data flow seeds.

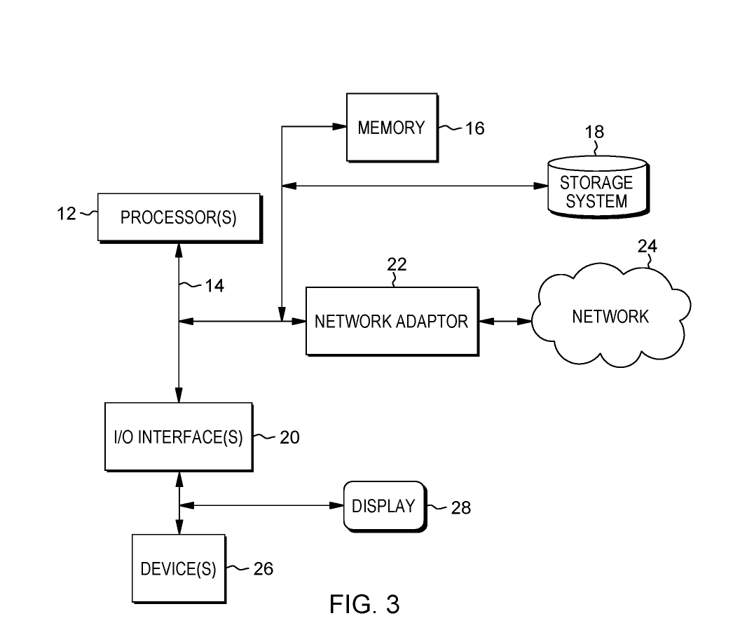

FIG. 3 illustrates a schematic of an exemplary computer or processing system that may implement the method of FIG. 1, in one set of embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of the computer system may include, but are not limited to, one or more processors or processing units 12, a system memory 16, and a bus 14 that couples various system components including system memory 16 to processor 12. The processor 12 may include a module that performs the methods described herein. The module may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. The computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-executed method comprising:
injecting one or more property violations into a program to be examined by a static analysis procedure, wherein the one or more property violations are to be enforced by the static analysis procedure;
recording a first list identifying the one or more injected property violations into a non-transitory computer-readable storage medium;
executing the static analysis procedure to detect at least one of the one or more injected property violations;
recording a second list identifying the detected at least one of the one or more injected property violations into the non-transitory computer-readable storage medium;
comparing the first list to the second list to gather a set of coverage metrics for the static analysis procedure, wherein the comparing identifies a first set of injected property violations that are not identified by the static analysis procedure, and a second set of injected property violations that are identified by the static analysis procedure; and
generating a coverage metrics report using the first and second sets of injected property violations, wherein the coverage metrics report provides an indication as to an extent that the static analysis procedure is able to detect one or more vulnerabilities in the program.

2. The method of claim 1 wherein the one or more property violations are inserted at random locations within the program.

3. The method of claim 1 wherein the one or more property violations are inserted at designated, specified, or predetermined locations within the program.

4. The method of claim 1 wherein the one or more property violations are inserted at both designated and random locations within the program.

5. The method of claim 1 wherein the one or more property violations are injected into the program by synthesizing one or more encapsulated code fragments that violate one or more properties to be verified by the static analysis procedure.

6. The method of claim 5 wherein each of the encapsulated code fragments represents a vulnerable flow having a pre-specified set of characteristics.

7. The method of claim 6 wherein the vulnerable flow involves at least one of a heap or a stack.

8. The method of claim 6 wherein the vulnerable flow is of a variable length.

9. An apparatus comprising a processor and a non-transitory computer-readable memory coupled to the processor, wherein the memory comprises instructions which, when executed by the processor, cause the processor to:
inject one or more property violations into a program to be examined by a static analysis procedure, wherein the one or more property violations are to be enforced by the static analysis procedure;
record a first list identifying the one or more injected property violations into the non-transitory computer-readable memory;
execute the static analysis procedure to detect at least one of the one or more injected property violations;
record a second list identifying the detected at least one of the one or more injected property violations into the non-transitory computer-readable memory;
compare the first list to the second list to gather a set of coverage metrics for the static analysis procedure, wherein the comparing identifies a first set of injected property violations that are not identified by the static analysis procedure, and a second set of injected property violations that are identified by the static analysis procedure; and
generate a coverage metrics report using the first and second sets of injected property violations, wherein the coverage metrics report provides an indication as to an extent that the static analysis procedure is able to detect one or more vulnerabilities in the program.

10. The apparatus of claim 9 wherein the one or more property violations are inserted at random locations within the program.

11. The apparatus of claim 9 wherein the one or more property violations are inserted at designated, specified, or predetermined locations within the program.

12. The apparatus of claim 9 wherein the one or more property violations are inserted at both designated and random locations within the program.

13. The apparatus of claim 9 wherein the one or more property violations are injected into the program by synthesizing one or more encapsulated code fragments that violate one or more properties to be verified by the static analysis procedure.

14. The apparatus of claim 13 wherein each of the encapsulated code fragments represents a vulnerable flow having a pre-specified set of characteristics.

15. The apparatus of claim 14 wherein the vulnerable flow involves at least one of a heap or a stack.

16. The apparatus of claim 14 wherein the vulnerable flow is of a variable length.

17. A computer program product comprising a computer-readable storage medium having a computer-readable analysis program stored therein, wherein the computer-readable analysis program, when executed on a computer system comprising at least one processor, causes the processor to:
inject one or more property violations into a program to be examined by a static analysis procedure, wherein the one or more property violations are to be enforced by the static analysis procedure;
record a first list identifying the one or more injected property violations into the non-transitory computer-readable storage medium;
executing the static analysis procedure to detect at least one of the one or more injected property violations;
recording a second list identifying the detected at least one of the one or more injected property violations into the non-transitory computer-readable storage medium;
comparing the first list to the second list to gather a set of coverage metrics for the static analysis procedure, wherein the comparing identifies a first set of injected property violations that are not identified by the static analysis procedure, and a second set of injected property violations that are identified by the static analysis procedure; and
generating a coverage metrics report using the first and second sets of injected property violations, wherein the coverage metrics report provides an indication as to an extent that the static analysis procedure is able to detect one or more vulnerabilities in the program.

18. The computer program product of claim 17 wherein the one or more property violations are inserted at random locations within the program.

19. The computer program product of claim 17 wherein and the one or more property violations are inserted at designated, specified, or predetermined locations within the program.

20. The computer program product of claim 19 wherein the one or more property violations are injected into the program by synthesizing one or more encapsulated code fragments that violate one or more properties to be verified by the static analysis procedure.
